(19) United States
(12) Patent Application Publication
(10) Pub. No.: US 2005/0161410 A1
(43) Pub. Date: Jul. 28, 2005

(54) System, method and composition for treatment of wastewater

(76) Inventors: Gregg L. Wilson, Bellingham, WA (US); Mary B. Hess, Bellingham, WA (US)

Correspondence Address: HUGHES LAW FIRM, PLLC, PACIFIC MERIDIAN PLAZA, SUITE 302, 4164 MERIDIAN STREET, BELLINGHAM, WA, 98226-5583, US

(21) Appl. No.: 10/984,255

(22) Filed: Nov. 8, 2004

Related U.S. Application Data
(60) Provisional application No. 60/518,358, filed on Nov. 6, 2003.

(51) Int. Cl. B01D 53/48

(52) U.S. Cl. 210/763; 423/244.01; 210/749

(57) ABSTRACT

A method and system for treating wastewater having therein a wastewater component comprises sulfur and/or sulfur compounds. Two metal catalysts are added to the wastewater, namely a primary catalyst which in its catalytic state is capable of accelerating conversion of said wastewater component at least in part to SO₄ and a secondary catalyst which is capable of at least in part re-oxidizing said catalyst to, and/or maintaining said primary catalyst in, said catalytic state. In one embodiment the primary catalyst can be selected from a group comprising cobalt, nickel, iron, manganese and combinations thereof, with copper being the secondary catalyst. Other candidates for the primary and secondary catalyst are listed in the text of the application.

### RELATED APPLICATIONS

This application claims priority benefit of U.S. Ser. No. 60/518,358 filed Nov. 6, 2003.

### BACKGROUND OF THE INVENTION

a) Field of the Invention

The system and method of the present invention relates to the treatment of wastewater, and in the embodiments that are disclosed herein the treatment of wastewater containing sulfur dioxide that has been removed from gaseous exhaust, and possibly other applications.

b) Background Art

There are various commercial installations (e.g. power plants), which involve the combustion of conventional fuels, such as natural gas, petroleum, and coal. Quite often these fossil fuels contain a small percentage of sulfur and other impurities. Thus, the gaseous exhaust resulting from combustion of these fuels is generally treated in some manner to remove these impurities, such as passing the gaseous combustion products through scrubbers.

The sulfur in the gaseous exhaust resulting from the combustion of these fossil fuels is generally not present as free, elemental sulfur but as an integral part of many organic compounds. If the fuels are burned in their natural state, one of the products of combustion is sulfur dioxide, which is toxic and corrosive to all biology. It is the primary component of acid rain, which defoliates forests, and is injurious to humans.

Although natural gas can be readily cleansed of sulfur compounds, this action is difficult for petroleum and impossible for coal. A recent advance at oil refineries is the purposeful removal of sulfur from gasoline, diesel and fuel oils. Even when sulfur compounds are removed from petroleum products, prior to their end use, the common end result is a vapor stream containing sulfur dioxide.

Refinery operations, that use catalysts for breaking down heavy compounds to gasoline-like compounds or reforming lighter compounds into light liquid products, also lead to the generation of sulfur dioxide. The catalyst beds become slowly poisoned with sulfur and other compounds over their operational life. These catalysts are regenerated by burning off the sulfur—resulting in sulfur dioxide.

Calcining coke operations also produce sulfur oxides as the coke is heated to drive off volatile impurities. The off-gas, from the calcining process, is treated using a quenching process that scrubs the vapor and reduces the temperature of the off-gas stream.

Natural gas production facilities often release Hydrogen Sulfide (H₂S) gas as a by-product of production. If H2S is present in large concentrations, it is scrubbed from the natural gas and either sent to sulfur plants for 90% recovery or incinerators with scrubbers.

Another major source of sulfur dioxide is metal smelters. The metal ore is commonly in the form of metal-sulfur salt or contains secondary metal-sulfur salts. The extraction of the metal entails the necessary release of sulfur dioxide.

Other major sulfur dioxide producers are pulp & paper, hydraulic cement, food, pharmaceutical, inorganic chemical, fertilizer, glass, and resin manufacturers. Waste incinerators, landfills, and other waste treatment operations also produce sulfur dioxide that could be scrubbed or quenched from the air exhausts.

Sulfur dioxide bearing vapor streams, whether they are an end result of sulfur removal processes or an end result of fuel combustion, are commonly treated by passing the vapor through some type of scrubber or quencher. The scrubber uses water mixed with a caustic solution of, for example, NaOH, Na₂CO₃ or Ca(OH)₂. The caustic in the water reacts with the sulfur dioxide, an acid gas, to form neutral salts in the water. As the acidic SO₂ dissolves in the water, the caustic species reacts with it to form the bisulfite ion, HSO₃⁻, and the sulfite ion, SO₃⁼. These ions have no vapor pressure.

Although this process removes the problem gas from the air, it remains a pollutant in the water. Any mechanism that can oxidize the sulfite to sulfate will convert a pollutant (SO₃) into an innocuous, non-volatile, non-toxic, non-reactive species (SO₄).

Absorbing oxygen into the sulfite-laden water does not result in fast, efficient oxidation of sulfite. Typically several absorption towers must be used in series to convert the sulfite to sulfate. The embodiments of the present invention are directed to the task of alleviating such problems.

### BRIEF DESCRIPTION OF THE DRAWINGS

FIG. 1, is a schematic drawing illustrating the overall system of the present invention where there is a sulfite oxidation facility in which embodiments of the present invention are incorporated, and also illustrating the overall method;

FIG. 2 is a side elevational view of a prior art scrubber from which the wastewater is generated for treatment by the system shown in FIG. 1; and

FIG. 3 is a longitudinal sectional view of a second type of oxidation tower, which differs from that shown in FIG. 1.

FIG. 4 is a side elevational view of a laboratory testing apparatus for laboratory scale testing of various catalysts for the oxidation of sulfite in water;

FIGS. 5, 6 and 7 are recordings of actual test results for oxidation test runs without catalyst and with catalyst;

### DESCRIPTION OF THE EMBODIMENTS

By way of background information, analysis which has been conducted relative to developing these embodiments of the present invention reveals that metal ions can act as a catalyst, but most have relatively poor performance. In general present analysis indicates that a more effective solitary catalyst, is the cobalt ion, Co⁺⁺. In fact, the catalyst efficiency of cobalt may be so high that the cobalt concentration needs to be only about one part per million when the sulfite concentration is thousands of parts per million. The process has the potential of being very fast, even down to a temperature of 60° F.

However, two entities can poison the catalytic process by inactivating the cobalt ion, namely:
i) The first entity can be an organic anion, especially any chelate, such as EDTA. The chelate will encompass cobalt ion by charge attraction and geometrically surround it. This makes the cobalt ion largely non-functional;
ii) The second entity is any metal ion that will reduce the cobalt ion from a plus two charge to a plus one charge. In effect, this poisonous metal ion competes against the sulfite ion for the opportunity of reducing the cobalt ion charge. An example is the nickel ion.

In the process of this embodiment of the present invention, a secondary metal ion can substantially alleviate those problems by use as a secondary metal catalyst. Present analysis indicates that the secondary metal catalyst re-oxidizes the primary catalyst ion, returning the primary catalyst ion to its catalytic state. In addition, this secondary metal ion also counteracts the effect of both organic anions, especially chelates, and poisonous metal ions such as nickel. Further, the secondary metal ion frees the primary catalyst ion from a chelate and takes its place within the chelate-metal ion complex. It also counteracts poisonous metal ions such as nickel by allowing itself to be reduced in charge instead of allowing the primary catalyst ion to be reduced in charge.

With this secondary metal ion, analysis further indicates that the whole reaction sequence is as follows, where M, is the primary catalyst and M₂ is the secondary catalyst.
SO₃⁼+M₁⁺⁺→SO₃⁻+M₁⁺
SO₃⁻+O₂→SO₅⁻
SO₃⁻+SO₅−2 SO₄⁻
M₂⁺+SO₄⁻→M₂⁺⁺+SO₄⁼
M₁⁺+M₂⁺⁺→M₁⁺⁺+M₂⁺

The cobalt ion is well suited for the reduction of the sulfite ion from a minus two charge to a minus one charge in the first reaction step, and the secondary metal ion is well suited for oxidation of the sulfate ion from the minus one charge to the minus two charge in the fourth reaction step. With the combination of these, the entire reaction system becomes much faster than it is with only a primary catalyst ion alone.

The following four metal ion combinations have given evidence that they catalyze the sulfite oxidation reaction, and counteract the effect of chelates or poisonous metal ions:
i) Cobalt ion, Co⁺⁺ plus Copper ion, Cu⁺⁺ (1 ppm Co⁺⁺, 1 ppm Cu⁺⁺);
ii) Nickel ion, Ni⁺⁺ plus Copper ion, Cu⁺⁺ (1 ppm Ni⁺⁺, 1 ppm Cu⁺⁺);
iii) Iron ion, Fe⁺⁺ plus Copper ion, Cu⁺⁺ (1 ppm Fe⁺⁺, 1 ppm Cu⁺⁺);
iv) Manganese ion, Mn⁺⁺ plus Copper ion, Cu⁺⁺ (1 ppm Mnz⁺⁺, 1 ppm Cu⁺⁺)

As indicated earlier, the combination the first of these has been demonstrated to be most effective.

The first metal ion is the primary catalyst, and the second metal ion counteracts chelates and poisonous metal ions and boosts the expended primary catalyst ion back to its active catalyst state.

By extension of this double metal catalyst theory method, the following metal ions are proposed as candidates for either the primary catalyst role or the secondary catalyst role:
Titanium, Vanadium, Chromium, Niobium, Technetium (radioactive), Palladium, Tin, Rhenium, Osmium, Iridium, Platinum, Gold, Mercury, Thallium, Lead, Bismuth, Cerium, Samarium, Europium, and Ytterbium.

To the best knowledge of the applicants, it is difficult to predict which combination of any two or more metal catalysts would be effective, and testing of the various combinations would likely be required. For example, nickel was used as the secondary metal catalyst for use in combination with cobalt as the primary catalyst. This did not turn out to be effective. However, copper was found to work quite well as the secondary metal catalyst for cobalt as the primary metal catalyst. Two criteria which should be considered in selecting these catalysts are as follows. The metal which is to be used as the secondary catalyst should (present analysis indicates) have the capability to draw an electron from the primary catalyst, and also function to tie up the chelates. A second factor to be considered is that some of the candidates listed above have a higher degree of toxicity, and this may create other problems. Further, some of the above candidates are rare earth elements and are rather expensive.

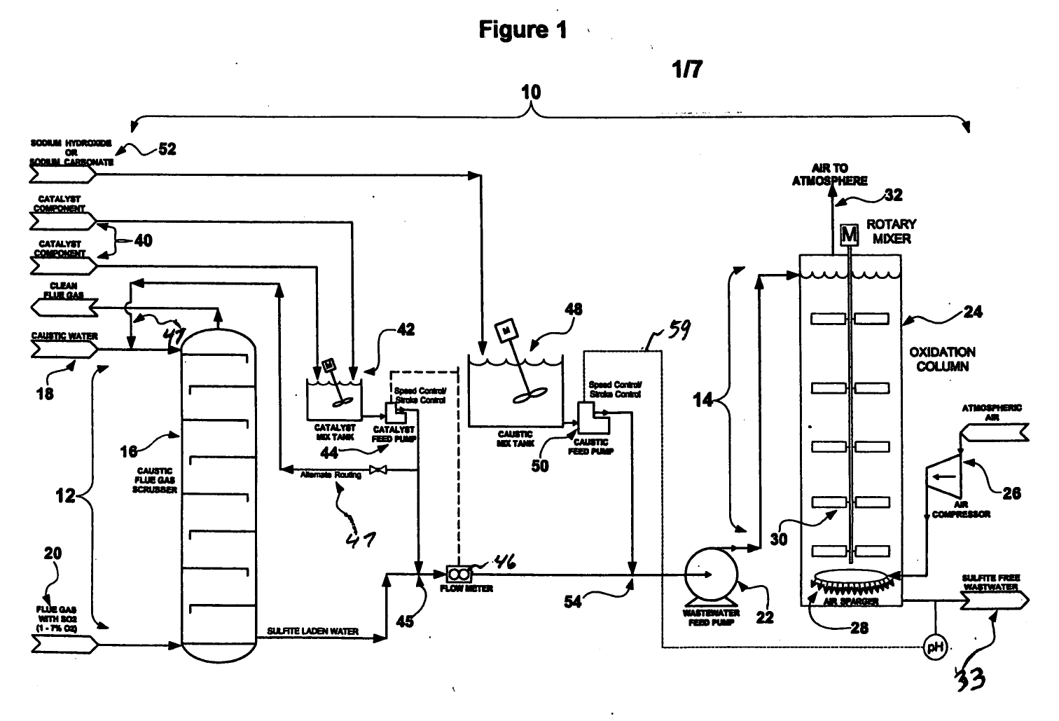

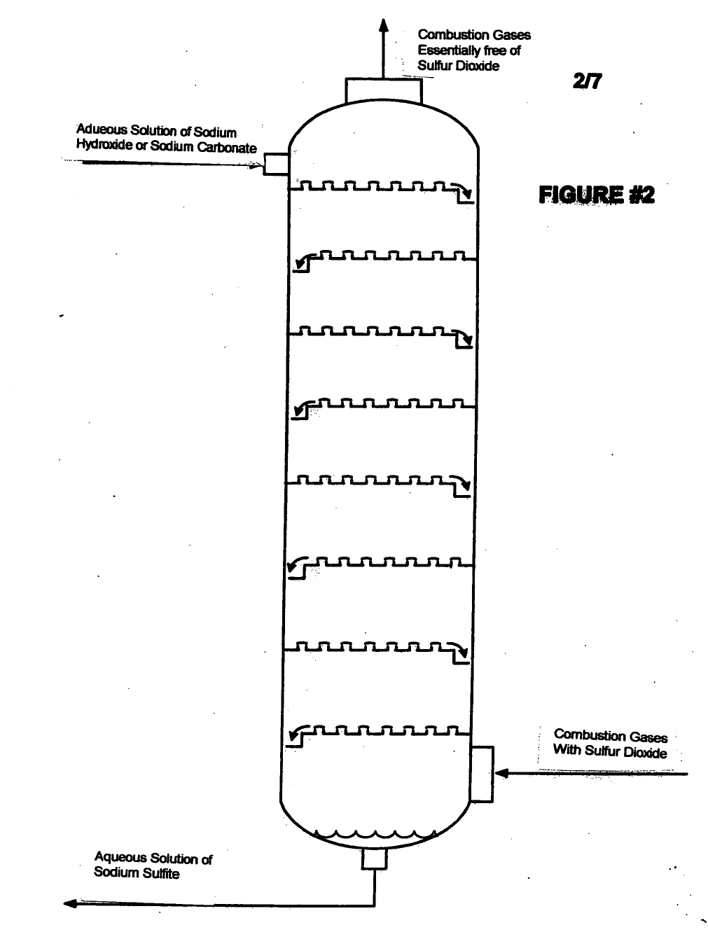

The overall system design of the embodiments is given in FIG. 1, which portrays a facility for treating a gaseous flow stream containing sulfur oxides, with the apparatus and method of embodiments of the present invention being incorporated therein. It is believed that a better understanding of the overall system and method of the present invention and also the details of the various embodiments associated therewith will be obtained by first describing the components of the system features which already existed in the prior art, and then directing attention to the newly added components and functions.

With further reference to FIG. 1, the components of the system 10 which already exist in the prior art are primarily the scrubber section 12 and the oxidation section 14. The scrubber section 12 further comprises a caustic flue gas scrubber 16 or a scrubber or quencher used in other industrial applications. There is a source 18 of caustic water which directs the water into the upper end portion of the scrubber 16 and a flue gas source 20, including other gaseous substances containing sulfur dioxide SO₂. The sulfite laden wastewater exits from the bottom part of the scrubber 16 and is directed toward the oxidation section 14.

The oxidation section 14 comprises a wastewater feed pump 22 that receives the sulfite laden water and directs it to the upper end of an oxidation column 24 of the oxidation section 14.

There is an air compressor 26 which directs pressurized air into the bottom part of the oxidation column 24 and into an air sparger 28. There is typically a rotary mixer 30 within the oxidation column 24. The sulfite laden wastewater travels downwardly through the oxidation column 24 and, at the same time, the air from the air sparger 28 migrates upwardly through the oxidation column to be discharged at a upper air discharge vent location 32. The sulfite-free wastewater exits at the discharge location 33 with SO₄ being dissolved in the wastewater.

The components which have been described above exist or already may exist in a facility. Alternatively, the facility in which the embodiments of the present invention could be incorporated in a newly constructed facility which is structured to take advantage of the benefits of the present invention.

Returning again to FIG. 1, to describe now in more detail the various components of the method and the apparatus of the present invention, there is a source 40 of the two soluble metal salts, which comprise the catalyst formulation, and these are mixed together in the Catalyst Mix Tank 42 in the ratio of one copper atom for each cobalt atom. The catalyst is then injected by the catalyst feed pump 44 into the sulfite-laden wastewater at the location 45 on the basis of one mg each of cobalt and copper to each liter of wastewater. There is a flow meter 46 which gives flow rate information back to a speed control of the pump 44 to in turn control the rate of which the catalysts are directed into the wastewater stream. These components 42, 44 and 46 collectively function as catalyst feed section.

There is an alternative routing of the catalyst feed which is potentially viable. An upstream scrubber, which removes gaseous SO₂ from the vapor phase to the water phase, may be treating an exhaust gas that contains 1% to 7% oxygen. Consequently, when the scrubber dissolves SO₂, it will also dissolve some oxygen. Injecting the catalyst mix into the caustic water that enters the scrubber 16, will utilize the dissolved oxygen to oxidize sulfite in the water. This action converts sulfite to sulfate within the scrubber 16 and boosts the ability of the scrubber to dissolve more SO₂ vapor. This alternate routing is shown in FIG. 1 at 47. This injected catalyst at 46 will also perform the same function in the downstream oxidation column 24.

A caustic mix tank 48 and pump 50 then inject either sodium hydroxide, sodium carbonate or other caustic solution (which is received from a source 52) into the wastewater at a location 54 to achieve a desired pH for the reaction. In this embodiment, the optimum pH range in the reaction vessel is about 8 to 9. Because the oxidation reaction of sulfite to sulfate lowers the pH by about one count, the optimum feed pH for the wastewater for oxidation is about 9 to 10. When the pH is at some level above that, the cobalt and copper can begin to combine with the hydroxide ion. When this occurs, the cobalt and copper can cease to be catalysts. When the pH is at some lower level, sulfite can convert over to bisulfite, and bisulfite will not oxidize.

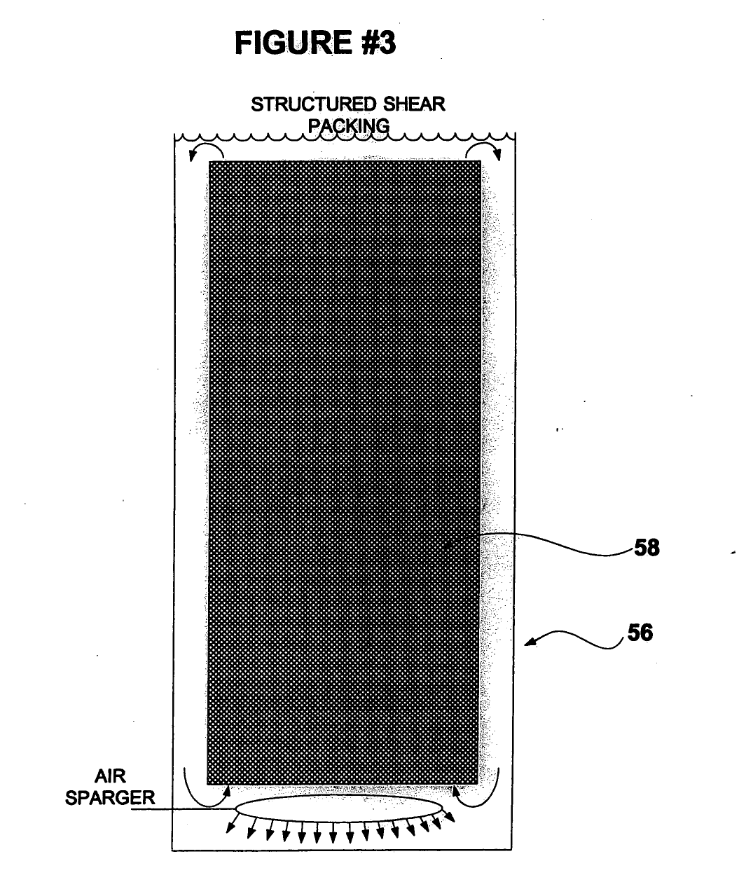

With catalyst addition and pH adjustment, the wastewater then enters the Oxidation Column 24. Atmospheric air is blown into the bottom of the column 24 as indicated earlier, and there are multi-blade propellers of the mixer 30 that are in the column 24 to agitate the water. Alternatively, there could be packing in the oxidation column, such as structured, high shear rate packing to cause the mixing of the air bubbles as shown in FIG. 3, where there is the oxidation tower 56 with the packing 58. There is a feedback loop, generally designated 59, by which the pH of the sulfite wastewater discharges from the oxidation column 24 is measured and sent to a speed control portion of this pump 50 to adjust the volumetric rate of discharge of the pump 50 to maintain the pH within the desired range. The catalyst formulation boosts the overall reaction rate by a factor of three to four, and accordingly in this embodiment, the oxygen transfer from the vapor phase to the liquid phase is to be maximized.

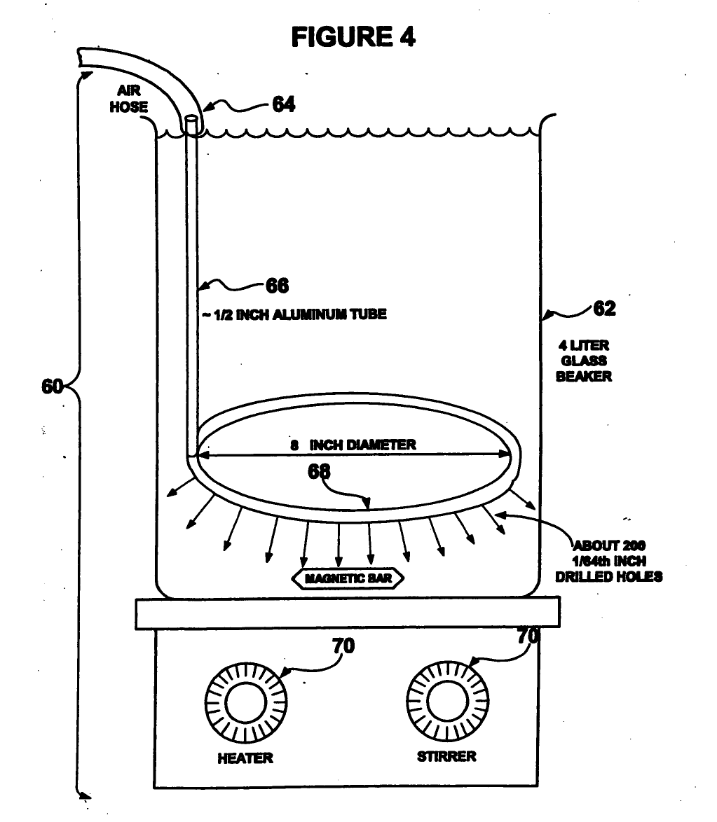

In this embodiment, the laboratory apparatus 60 for catalyst testing is presented in FIG. 4. This apparatus 60 comprises a beaker 62, an air hose 64 connected to a tube 66 that extends downwardly into the beaker 62. In the lower part of the beaker 62 there is an air sparger 68 which directs the air into the liquid in the beaker 62. There is a magnetically actuated stirrer (not illustrated in FIG. 4) at the bottom of the beaker. The control knobs 70 for the heater and the stirrer are indicated at 70. The air is injected in very small bubbles to maximize the surface area between air and water. It has been found satisfactory if the air is discharged through openings that are of a sufficiently small diameter by being made with a number 80 drill (which would make holes of about 1/64^{th} of an inch in diameter). The air bubbles remain in the water as long as practical to take advantage of the 21% oxygen concentration in air, and the water should undergo high turbulence to mix the water's oxygenated surface film with the bulk phase of the water. Air with 21% oxygen is used rather than an oxygen starved gas.

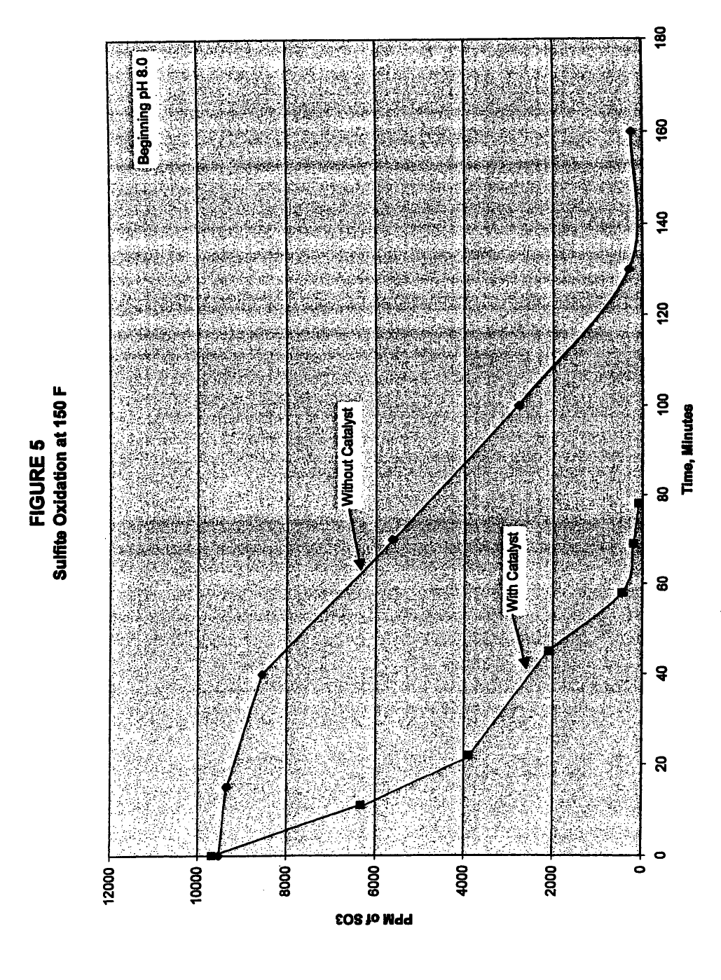

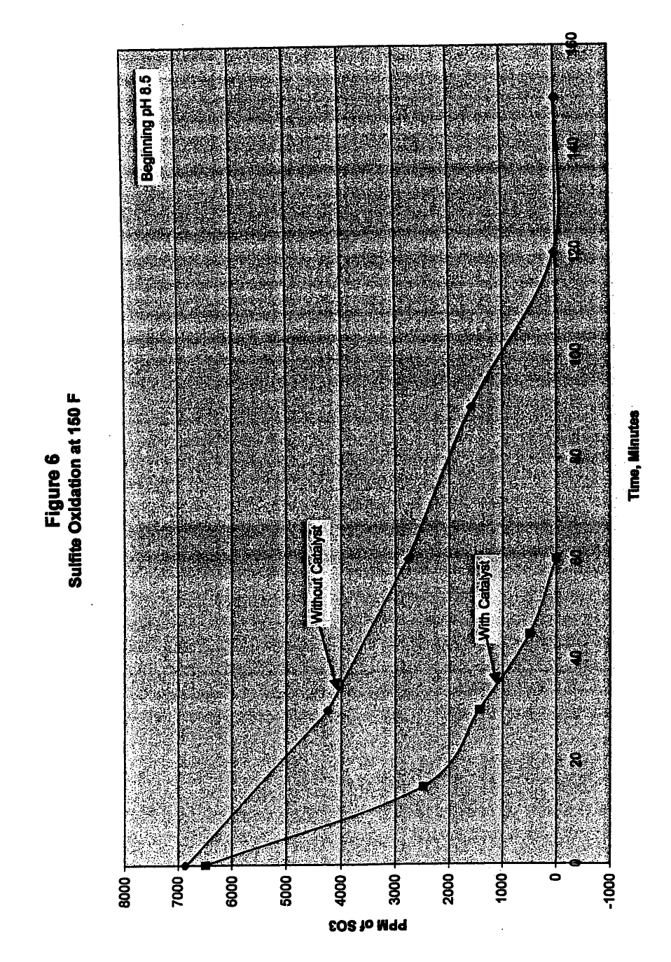

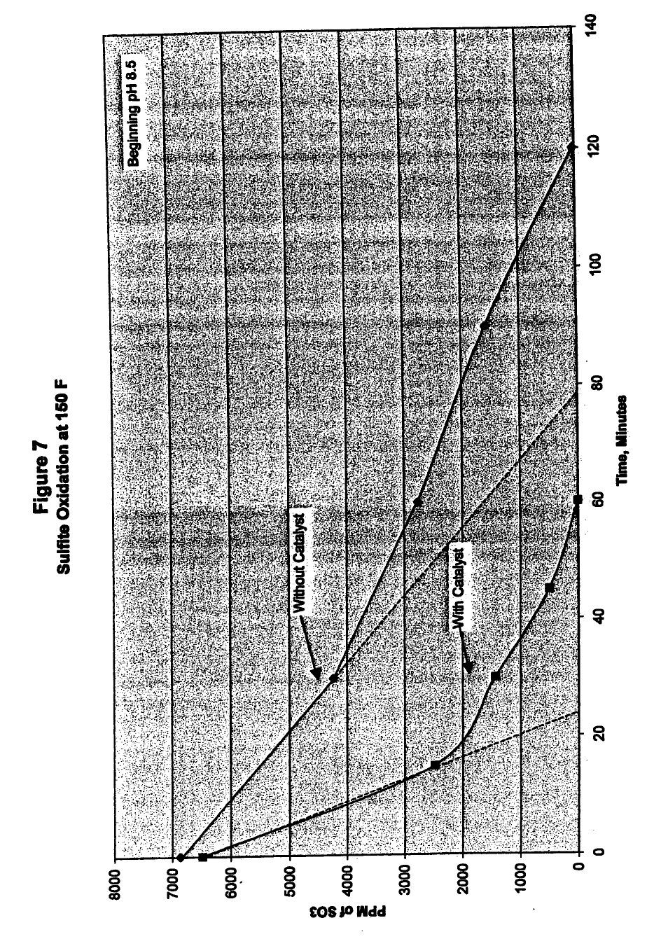

Typical results for an actual laboratory test are given in FIGS. 5, 6 and 7. Batch oxidation test runs are shown for no catalyst and the catalyst combination of cobalt-copper. FIG. 5 illustrates the results achieved with the beginning pH of 8.0 at a temperature of 150 degrees, both without any catalyst and with the catalysts. FIG. 6 has the same format as FIG. 5, except that the beginning pH is 8.5, again with the comparison being made without catalyst and with catalyst. FIG. 7 is essentially the same as FIG. 6, except that there have been added straight broken line extensions extending from the upper parts of the curve. The reason for this is that this data was taken with the test apparatus of FIG. 4 which is a batch testing apparatus and the results in a change of slope in the curve. If this were in an actual industrial application, where there is a continuous flow of the wastewater through the scrubber and the oxidation tower, the straight line extensions would be closer to the actual results achieved.

In the embodiment as illustrated in FIG. 1, in order to promote these factors there are the following features:
i) The oxidation column is relatively tall and narrow (e.g. 10 to 40 feet in height and 2 to 8 feet in diameter);
ii) The air is introduced through a ring sparger very near the bottom of the column;
iii) The holes in the air sparger point downward at about 45° degrees to keep them from plugging, and to horizontally disperse the air bubbles;
iv) There is a multi-bladed rotary mixer or structured packing in the column, either of which has a high shear effect on the rising air-water mixture. (This choice is more economic than a technical issue.)
   Commercially constructed oxidation columns are available. Scrubber equipment companies typically provide well-designed oxidation columns. Belco, Amerex, and Tri-Mer scrubber equipment vendors provide oxidation columns.

The following processing conditions have been found to be satisfactory in this embodiment:
i) The temperature of the wastewater is 60° F. to about 150 F.
ii) The pH can vary from about 7.0 to 9.5, and in a narrower range is about 8 to 9. It has been found that under certain conditions if the pH drops below about 7.0, then the air stream blown through the oxidation column can actually begin to strip sulfite from the water as SO₂;
iii) The catalytic ion concentration in the wastewater is about one mg per liter for each catalytic metal, but this could vary upwardly or downwardly depending on various conditions down by increments of 10% to, for example 2 mg or ½ mg per liter.
iv) The airflow through the oxidation column is about 10 to 20 times the amount of oxygen required for complete oxidation of all the sulfite or higher.
v) It has been found that a high level of an organic anion, which can deactivate the catalyst, can stop the oxidation reaction. A high level of a metal ion, which can deactivate the catalyst, can stop the oxidation reaction.

### EXAMPLE 1

Step 1: A four liter glass beaker was placed upon a laboratory mixer/heater.

Step 2: Four liters of refinery process water (containing sulfite) was poured into the glass beaker. A magnetic stir bar was placed in the beaker for mixing the solution.

Step 3: The laboratory mixer/heater was activated and the solution was heated to 150° F.

Step 4: The pH of the solution was measured to be 6.7

Step 5: Very small amounts of granular sodium carbonate were added to raise the pH to 8.5

Step 6: When the solution was stabilized at 150° F. and pH 8.5, a three ml solution was withdrawn, titrated for sulfite concentration and found to have ˜7,000 mg/liter sulfite.

Step 7: The air sparger (See FIG. 4) was lowered into the glass beaker.

Step 8: At the same time, four milligrams of cobalt and four milligrams of copper were added to the glass beaker (in the form of metal chlorides) and the air sparger was activated at a differential pressure of 7 to 8 psi.

Step 9: At about 15 minute intervals, a 3 ml sample of the process fluid was withdrawn from the glass beaker and tested for sulfite concentration by the standard titration method utilizing potassium iodide-iodate solution. At the same time, temperature and pH of the process water were measured and recorded.

Step 10: When the apparent sulfite had dropped to about 3 ppm or less, the experiment was terminated.

### EXAMPLE 2

Example 1 was repeated except no catalyst was added. Removal of sulfite took about three times as long as Example 1.

### EXAMPLE 3

Example 1 was repeated except the pH was adjusted to 8.0. Results were very close to Example 1.

### EXAMPLE 4

Example 1 was repeated except temperature was held at about 120° F. Results were very close to Example 1.

### EXAMPLE 5

Example 1 was repeated except that temperature was held at 80° F. Results were very close to Example 1.

### EXAMPLE 6

Example 1 was repeated except pH was held at 9.5. The result was very slow oxidation. This is to be expected since high pH would precipitate catalyst.

### EXAMPLE 7

Example 1 was repeated except that pH was set at 7.0. Oxidation was almost as slow as with no catalyst. This is to be expected since most of the sulfite was converted to bisulfite at this pH. Bisulfite will not oxidize.

### EXAMPLE 8

Example 1 was repeated except that one milligram concentration of nickel was substituted for copper, with cobalt remaining the same. Oxidation did not take place. Apparently the nickel acted as a poison to the catalytic process.

It is to be understood that various modifications could be changed in the system and method, and that while certain numerical values and limits are given, depending on various factors, this could be made somewhat higher or lower.

It has been found that with the catalyst combination in an oxidation column where the pH can be optimally set and air with 21% oxygen can be bubbled through the column, testing has demonstrated that loads of as much as 15,000 ppm sulfite can be reduced to the 1 to 5 ppm range.

1. A method of treating wastewater having therein a wastewater component comprising sulfur and/or sulfur compounds, said method comprising:
a) adding to said wastewater a primary metal catalyst which in its catalytic state is capable of accelerating conversions of said wastewater component at least in part to SO₄;
b) adding to said wastewater a secondary metal catalyst which is capable of at least in part re-oxidizing said catalyst to, and/or maintaining said primary catalyst in, said catalytic state; and
c) directing a gaseous substance comprising oxygen through the wastewater with the primary and secondary catalysts therein for oxidizing the wastewater component to product SO₄.

2. The method as recited in claim 1, wherein the primary catalyst and the second catalyst are selected so that the secondary metal catalyst is capable of drawing an electron away from the primary metal catalyst so that the primary metal catalyst is in its catalytic state.

3. The method as recited in claim 2, wherein the secondary catalyst has the capability of functioning to tie up chelates in the wastewater.

4. The method as recited in claim 3, wherein said primary catalyst is selected from a group of titanium, vanadium, chromium, niobium, technetium (radioactive), palladium, tin, rhenium, osmium, iridium, platinum, gold, mercury, thallium, lead, bismuth, cerium, samarium, europium, and ytterbium, and combinations thereof.

5. The method as recited in claim 4, wherein said secondary catalyst is selected from a group of titanium, vanadium, chromium, niobium, technetium (radioactive), palladium, tin, rhenium, osmium, iridium, platinum, gold, mercury, thallium, lead, bismuth, cerium, samarium, europium, and ytterbium, and combinations thereof.

6. The method as recited in claim 1 wherein said primary catalyst is selected from a group of titanium, vanadium, chromium, niobium, technetium (radioactive), palladium, tin, rhenium, osmium, iridium, platinum, gold, mercury, thallium, lead, bismuth, cerium, samarium, europium, and ytterbium, and combinations thereof.

7. The method as recited in claim 6, wherein said secondary catalyst is selected from a group of titanium, vanadium, chromium, niobium, technetium (radioactive), palladium, tin, rhenium, osmium, iridium, platinum, gold, mercury, thallium, lead, bismuth, cerium, samarium, europium, and ytterbium, and combinations thereof.

8. The method as recited in claim 1, wherein said primary catalyst is selected from a group comprising cobalt, nickel, iron, manganese and combinations thereof.

9. The method as recited in claim 8, wherein in secondary catalyst comprises copper.

10. The method as recited in claim 1, wherein said primary catalyst comprises cobalt.

11. The method as recited in claim 1, wherein the pH of the wastewater in which the primary and secondary catalyst are present and which have had the gaseous substance with oxygen pass there through is between about 9.5 to 7.

12. The method as recited in claim 11, wherein said pH is between about 9 to 8.

13. The method as recited in claim 11, wherein said pH is between about 9 to 8 and said primary metal catalyst comprises cobalt.

14. The method as recited in claim 11, wherein said primary catalyst comprises cobalt which is present in the wastewater at a concentration of at least as great as about ½ mg per liter of wastewater.

15. The method as recited in claim 14, wherein said concentration is at least as great as about 0.8 mg per liter of wastewater.

16. The method as recited in claim 14, wherein said concentration is at least about 1 mg per liter of wastewater.

17. The method as recited in claim 1, wherein said primary catalyst comprises cobalt, and said secondary catalyst comprises copper.

18. The method as recited in claim 1, wherein said cobalt is present in the wastewater in a concentration at least as great as ½ mg per liter of wastewater and said copper is present in said wastewater at a concentration of at least ½ mg. liter of wastewater.

19. The method as recited in claim 18, wherein said concentrations of the each of the cobalt and the copper is at least as great as about one mg per liter of wastewater.

20. The method as recited in claim 1, wherein said primary metal catalyst comprises cobalt, the pH of the wastewater in which the primary and secondary catalyst are present and which have had the gaseous substance with oxygen pass therethrough is between about 9.5 to 7, and the temperature of the wastewater that is passing through the oxidation section is between about 150° F. and 60° F.

21. The method as recited in claim 1, wherein said wastewater results from passing a gaseous composition containing at least sulfur dioxide through caustic water to convert the sulfur dioxide to SO₃ and the gaseous substance comprising oxygen is passed through the wastewater to convert SO₃ to SO₄.

22. The method as recited in claim 21, wherein the pH of the wastewater in which the primary and secondary catalyst are present and which have had the gaseous substance with oxygen pass therethrough is between about 9.5 to 7:

23. The method as recited in claim 21, wherein said primary secondary catalyst are fed into said caustic water prior to the gaseous stream containing at least SO₂ is passed through the caustic water.

24. The method as recited in claim 21, wherein said primary secondary catalyst are fed into said caustic water after to the gaseous stream containing at least SO₃ is passed through the caustic water.

25. A system for removing a sulfur component comprising sulfur and/or sulfur containing compounds from a gaseous substance and converting at least in part said sulfur and/or sulfur compounds to SO₄, said system comprising:
a) a scrubber/quencher into which both caustic water and said gaseous substance are directed to cause the sulfur component to be contained in and/or dissolved in said caustic water to produce a wastewater;
b) a catalyst source to provide a primary metals catalyst which in its catalytic state is capable of accelerating conversion at least in part of said sulfur component at least in part to SO₄, and a secondary metal catalyst which is capable at least in part of re-oxidizing said primary catalyst to, and/or maintaining said primary catalyst in, said catalytic state;
c) a catalyst feed section to feed said primary and secondary catalysts into said caustic water and/or said wastewater;
d) a pH control section to inject a pH adjustment component into said wastewater to maintain the wastewater within a desired range of pH;
e) an oxidation section arranged to receive the wastewater having the primary and secondary catalysts therein and with the pH within said desired range, and to direct oxygen through the wastewater to convert at least in part said sulfur component to SO₄.

26. The system as recited in claim 25, wherein said catalyst feed section comprises a catalyst receiving member to receive said first and second catalysts to provide a combined catalyst component, said catalyst feed section further comprising a catalyst feed pump to direct the combined catalyst to the wastewater, a flow meter to measure volumetric flow of the wastewater and a feedback loop from the flow meter to a control portion of the pump to control the concentration of the catalyst in the wastewater.

27. The system as recited in claim 26, wherein said pH control section comprises a source of a caustic component, a caustic feed pump to direct the caustic component into the wastewater, and a feedback loop which is responsive to pH of the wastewater passing through the oxidation section and which delivers a control signal to a control portion of the caustic pump to control its output.

28. The system as recited in claim 25, wherein said pH control section comprises a source of a caustic component, a caustic feed pump to direct the caustic component into the wastewater, and a feedback loop which is responsive to pH of the wastewater passing through the oxidation section and which delivers a control signal to a control portion of the caustic pump to control its output.

29. The system as recited in claim 25, wherein said primary and secondary catalysts are fed into said caustic water after said caustic water has had said sulfur component contained and/or dissolved therein to become wastewater.

30. The system as recited in claim 25, wherein prior to said sulfur component becoming contained and/or dissolved in said caustic water, said catalyst feed section injects said primary and secondary catalyst into said caustic liquid.

32. The system as recited in claim 25, wherein the primary catalyst and the second catalyst are selected so that the secondary metal catalyst is capable of drawing an electron away from the primary metal catalyst so that the primary metal catalyst is in its catalytic state.

33. The system as recited in claim 31, wherein the secondary catalyst has the capability of functioning to tie up chelates in the wastewater.

33. The system as recited in claim 25 wherein said primary catalyst is selected from a group of titanium, vanadium, chromium, niobium, technetium (radioactive), palladium, tin, rhenium, osmium, iridium, platinum, gold, mercury, thallium, lead, bismuth, cerium, samarium, europium, and ytterbium, and combinations thereof.

34. The system as recited in claim 33, wherein said secondary catalyst is selected from a group of titanium, vanadium, chromium, niobium, technetium (radioactive), palladium, tin, rhenium, osmium, iridium, platinum, gold, mercury, thallium, lead, bismuth, cerium, samarium, europium, and ytterbium, and combinations thereof.

35. A method of removing a sulfur component comprising and/or sulfur containing compounds from a gaseous substance and disposing of said sulfur and/or sulfur compounds at least in part as SO₄, said system comprising:
a) directing both caustic water and said gaseous substance through a scrubber/quencher to cause the sulfur component to become contained in, and/or dissolved in, said caustic water to produce a wastewater;
b) directing a primary metal catalyst which in its catalytic state is capable of accelerating conversion of said sulfur component to SO₄ and a secondary metal catalyst which is capable at least in part of re-oxidizing said primary catalyst to, and/or maintaining said primary catalyst in, said catalytic state, into said caustic liquid after said caustic liquid has passed through said scrubber/quencher or prior thereto to cause the sulfur component to become contained in and/or dissolved in said caustic water to provide a wastewater;
c) directing oxygen through the wastewater having the primary and secondary catalyst therein to convert at least in part the sulfur component to SO₄.
